(19) United States
(12) Patent Application Publication
(10) Pub. No.: US 2026/0132319 A1
(43) Pub. Date: May 14, 2026

(54) ADHESIVE COMPOSITION AND ADHESIVE FORMED FROM THE SAME

(71) Applicant: SHINY CHEMICAL INDUSTRIAL CO., LTD., Kaohsiung City (TW)

(72) Inventors: Kai-Chieh CHANG, Kaohsiung City (TW); Chi-Fa SUN, Kaohsiung City (TW)

(73) Assignee: SHINY CHEMICAL INDUSTRIAL CO., LTD., Kaohsiung City (TW)

(21) Appl. No.: 19/004,959

(22) Filed: Dec. 30, 2024

(30) Foreign Application Priority Data
Nov. 14, 2024 (TW) 113143813

(51) Int. Cl. C09J 133/14; C08F 220/18; C08F 220/28; C09J 4/00

(52) U.S. Cl. CPC C09J 133/14; C08F 220/1804; C08F 220/281; C09J 4/00; C08F 2800/20

(57) ABSTRACT

An adhesive composition includes a modified cinnamic acid monomer, a propylene glycol methyl ether acrylate monomer, an initiator, and a first solvent. The modified cinnamic acid monomer is formed by subjecting a component which includes cinnamic acid, 2-hydroxyethyl methacrylate, and a catalyst to an esterification reaction. The first solvent includes n-butyl acetate. An adhesive, which is formed by subjecting the adhesive composition to a cross-linking reaction, is also provided.

### CROSS-REFERENCE TO RELATED APPLICATION

This application claims priority to Taiwanese Invention Patent Application No. 113143813, filed on Nov. 14, 2024, the entire disclosure of which is incorporated by reference herein.

### FIELD

The disclosure relates to an adhesive composition and an adhesive formed from the same.

### BACKGROUND

In the manufacturing of an electronic product, a photo-releasable adhesive serving as a temporary adhesive is frequently used to bond two component parts of the electronic product together. When a conventionally used photo-releasable adhesive is subjected to irradiation with light having a certain wavelength, the adhesion thereof may decrease, causing the two component parts that are bonded by the conventionally used photo-releasable adhesive to separate from each other. However, after the irradiation, the adhesion strength of the conventionally used photo-releasable adhesive cannot be restored to its original adhesion strength (i.e., an adhesion strength before the irradiation), making the conventionally used photo-releasable adhesive incapable of being reused. Therefore, those skilled in the art strive to develop a new photo-releasable adhesive that, after being subjected to irradiation with light having a specific wavelength, is capable of restoring the adhesion strength of the same to an adhesion strength before irradiation, so that the new photo-releasable adhesive can be reused.

TW 201819349 A discloses a photosensitive adhesive whose adhesion can be repeatedly altered by irradiation. The photosensitive adhesive is formed by polymerization of a cinnamic acid monomer and a monomer A under irradiation of light having a wavelength ranging from 200 nm to 280 nm, and has a relatively strong adhesion. Specifically, the photosensitive adhesive is a polymerization product including polymerization units each of which has a benzene ring derived from the cinnamic acid monomer and an unsaturated bond that is most adjacent to the benzene ring. Under irradiation of light having a wavelength ranging from 280 nm to 400 nm, the unsaturated bond of one of the polymerization units undergoes a reversible cyclization reaction with the unsaturated bond of another one of the polymerization units, which reduces the adhesion of the photosensitive adhesive. The monomer A includes a polyurethane monomer structure or an acrylic monomer structure which is derived from propylene glycol methyl ether acrylate (OBA), butyl acrylate (BA), methyl methacrylate (MMA), ethylhexyl acrylate (EHA), glycidyl methacrylate (GMA), or acrylic acid (AA).

Considering that an adhesive that is capable of changing its adhesion upon illumination may have a wide range of applications, those skilled in the art are committed to developing various novel adhesive products to meet the changing needs of the market.

### SUMMARY

Therefore, in a first aspect, the present disclosure provides an adhesive composition which can alleviate at least one of the drawbacks of the prior art. The adhesive composition includes:
a modified cinnamic acid monomer formed by subjecting a component which includes cinnamic acid, 2-hydroxyethyl methacrylate, and a catalyst to an esterification reaction,
a propylene glycol methyl ether acrylate monomer,
an initiator, and
a first solvent including n-butyl acetate.

In a second aspect, the present disclosure provides an adhesive which can alleviate at least one of the drawbacks of the prior art, and which is formed by subjecting the aforesaid adhesive composition to a cross-linking reaction. The adhesive includes modified cinnamic acid structural units each of which is represented by formula (I), and propylene glycol methyl ether acrylate structural units each of which is represented by formula (II),

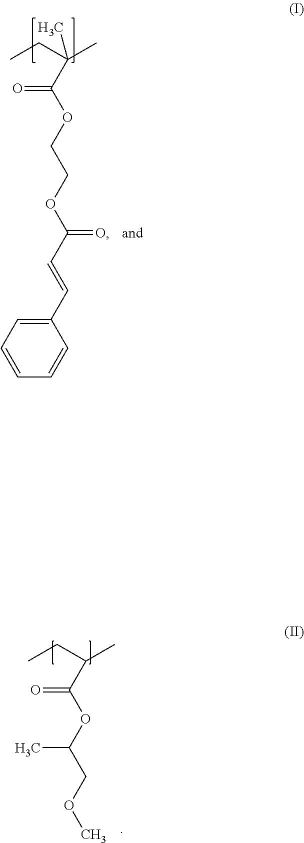

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides an adhesive composition, which includes a modified cinnamic acid monomer, a propylene glycol methyl ether acrylate monomer, an initiator, and a first solvent.

According to the present disclosure, the modified cinnamic acid monomer is formed by subjecting a component which includes cinnamic acid, 2-hydroxyethyl methacrylate (HEMA), and a catalyst to an esterification reaction.

According to the present disclosure, the modified cinnamic acid monomer is represented by formula (III),

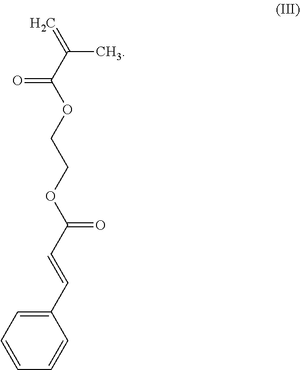 [SMILES: C=C(C)C(=O)OCCOC(=O)/C=C/c1ccccc1]

According to the present disclosure, the type of the catalyst is not particularly limited, as long as the catalyst is suitable for conducting the esterification reaction between the cinnamic acid and the HEMA. An example of the catalyst may include, but is not limited to, dioctyltin dilaurate. In an exemplary embodiment, the catalyst is dioctyltin dilaurate.

In some embodiments, the component may further include a second solvent. An example of the second solvent may include, but is not limited to, propylene glycol methyl ether acetate. In an exemplary embodiment, the second solvent is propylene glycol methyl ether acetate.

According to the present disclosure, the propylene glycol methyl ether acrylate monomer is represented by formula (IV),

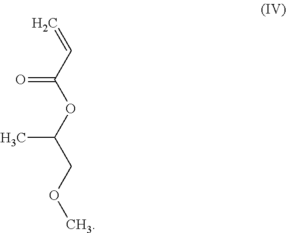

According to the present disclosure, the initiator is used to allow a cross-linking reaction between the modified cinnamic acid monomer and the propylene glycol methyl ether acrylate monomer to proceed, thereby allowing the adhesive composition to form an adhesive. The type of the initiator is not particularly limited, as long as the initiator is suitable for conducting the cross-linking reaction. In some embodiments, the initiator may be selected from the group consisting of a thermal initiator, a photoinitiator, and a combination thereof. In an exemplary embodiment, the initiator is the thermal initiator. An example of the thermal initiator may include, but is not limited to, dimethyl 2,2′-azobis(2-methylpropionate). In an exemplary embodiment, the thermal initiator is dimethyl 2,2′-azobis(2-methylpropionate).

According to the present disclosure, the first solvent includes n-butyl acetate. In certain embodiments, in addition to the n-butyl acetate, the first solvent may further include propylene glycol methyl ether acetate, and the n-butyl acetate is present in a volume amount greater than that of the propylene glycol methyl ether acetate (specifically, a volume ratio of the n-butyl acetate to the propylene glycol methyl ether acetate is greater than 1 in decimal form). In an exemplary embodiment, a volume ratio of the n-butyl acetate to the propylene glycol methyl ether acetate is 2:1.

In certain embodiments, based on a total amount of the modified cinnamic acid monomer as 100 parts by weight, the propylene glycol methyl ether acrylate monomer may be present in an amount ranging from 100 parts by weight to 2000 parts by weight, and the initiator may be present in an amount ranging from 4 parts by weight to 6 parts by weight.

In certain embodiments, based on a total amount of the modified cinnamic acid monomer, the propylene glycol methyl ether acrylate monomer, and the initiator as 100 wt %, the modified cinnamic acid monomer may be present in an amount ranging from 4.9 wt % to 9.9 wt %, the propylene glycol methyl ether acrylate monomer may be present in an amount ranging from 90 wt % to 95 wt %, and the initiator may be present in an amount ranging from 0.1 wt % to 0.5 wt %.

In certain embodiments, based on 100 wt % of the adhesive composition, the total amount of the modified cinnamic acid monomer, the propylene glycol methyl ether acrylate monomer, and the initiator may range from 30 wt % to 60 wt %, and the first solvent may be present in an amount ranging from 40 wt % to 70 wt %.

In certain embodiments, the adhesive composition may further include an acrylic monomer selected from the group consisting of hydroxyethyl acrylate, butyl acrylate, and 2-ethylhexyl acrylate. In an exemplary embodiment, the acrylic monomer is 2-ethylhexyl acrylate. By virtue of the acrylic monomer, the adhesive formed from the adhesive composition may have a glass transition temperature of −60° C.

In certain embodiments, based on a total amount of the modified cinnamic acid monomer, the propylene glycol methyl ether acrylate monomer, the acrylic monomer, and the initiator as 100 wt %, the modified cinnamic acid monomer may be present in an amount ranging from 4.9 wt % to 9.9 wt %, a total amount of the propylene glycol methyl ether acrylate monomer and the acrylic monomer may range from 90 wt % to 95 wt %, and the initiator may be present in an amount ranging from 0.1 wt % to 0.5 wt %.

In certain embodiments, based on 100 wt % of the adhesive composition, the total amount of the modified cinnamic acid monomer, the propylene glycol methyl ether acrylate monomer, the acrylic monomer, and the initiator may range from 30 wt % to 60 wt %, and the first solvent may be present in an amount ranging from 40 wt % to 70 wt %.

The present disclosure also provides an adhesive, which is formed by subjecting the aforesaid adhesive composition to a cross-linking reaction. The adhesive includes modified cinnamic acid structural units each of which is represented by formula (I), and propylene glycol methyl ether acrylate structural units each of which is represented by formula (II),

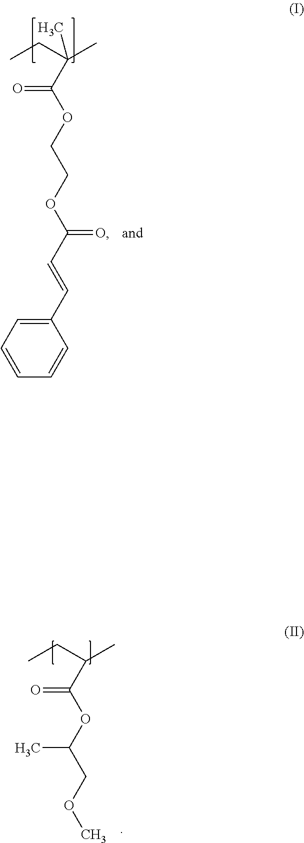

In some embodiments, the adhesive may further include a first structural unit which is represented by formula (V),

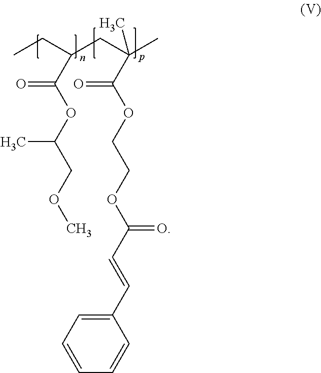

In certain embodiments, when the adhesive composition further includes the acrylic monomer, the adhesive formed from such adhesive composition may further include acrylic structural units which are capable of effectively controlling the glass transition temperature of the adhesive, and each of which is represented by formula (VI),

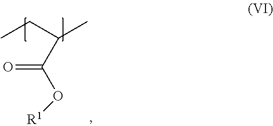

where R¹ is selected from the group consisting of —CH₂CH₂OH, —CH₂CH(CH₂CH₃)CH₂CH₂CH₂CH₃, and —CH₂CH₂CH₂CH₃.

According to the present disclosure, one of the acrylic structural units may bind to one of the propylene glycol methyl ether acrylate structural units (as represented by formula (II)) in the first structural unit (as represented by formula (V)), thereby forming a second structural unit which is represented by formula (VII),

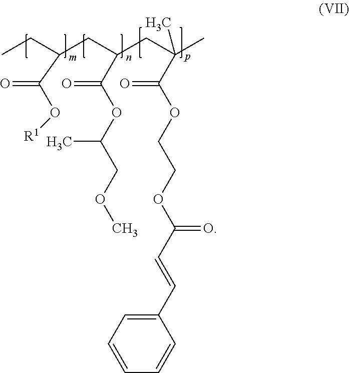

It should be noted that arrangement of the modified cinnamic acid structural unit(s), the propylene glycol methyl ether acrylate structural unit(s), and the acrylic structural unit(s) in the second structural unit is not limited to that presented in formula (VII), and can be arbitrarily adjusted.

In other embodiments, when the acrylic monomer in the adhesive composition is hydroxyethyl acrylate, R¹ in formula (VI) is —CH₂CH₂OH; accordingly, the adhesive thus obtained may include the second structural unit which is represented by formula (VII-1),

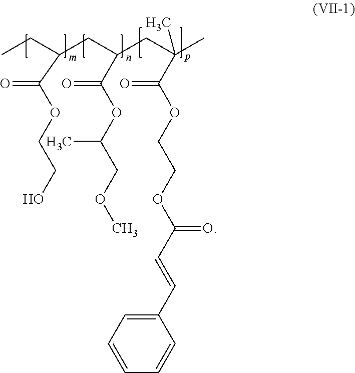

In still other embodiments, when the acrylic monomer in the adhesive composition is butyl acrylate, R¹ in formula (VI) is —CH₂CH₂CH₂CH₃; accordingly, the adhesive thus obtained may include the second structural unit which is represented by formula (VII-2),

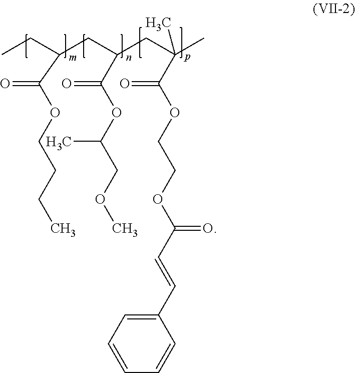

In each of formulae (V), (VII), (VII-1), and (VII-2), m (not included in formula (V)), n, and p are each an integer, and can be used to represent a number ratio of the acrylic structural unit(s) (number thereof presented by “m”), the propylene glycol methyl ether acrylate structural unit(s) (number thereof presented by “n”), and the modified cinnamic acid structural unit(s) (number thereof presented by “p”). Additionally, the numerical relationship among m, n, and p is m>n>p. It is noteworthy that the glass transition temperature of the adhesive can be controlled by adjusting the number ratio of the acrylic structural unit(s), the propylene glycol methyl ether acrylate structural unit(s), and the modified cinnamic acid structural unit(s), that is to say, by adjusting the numerical relationship among m, n, and p.

In certain embodiments, the glass transition temperature of the adhesive may range from −40° C. to −60° C., thus providing the adhesive with good adhesion. In an exemplary embodiment, the glass transition temperature of the adhesive is −40° C. In some embodiments, when the acrylic monomer in the adhesive composition is 2-ethylhexyl acrylate, the glass transition temperature of the adhesive thus formed is −60° C.

The method for preparing the adhesive of the present disclosure is described as follows. In certain embodiments, the modified cinnamic acid monomer, the propylene glycol methyl ether acrylate monomer, the initiator, and the first solvent are mixed to form an adhesive composition, followed by subjecting the adhesive composition to the cross-linking reaction, thereby forming the adhesive. In certain embodiments, the modified cinnamic acid monomer, the propylene glycol methyl ether acrylate monomer, the acrylic monomer, the initiator, and the first solvent are mixed to form the adhesive composition, followed by subjecting the adhesive composition to the cross-linking reaction, thereby forming the adhesive. It should be noted that the adhesive obtained from the cross-linking reaction still has the first solvent remaining therein.

In certain embodiments, each of the modified cinnamic acid structural units may have a benzene ring and an unsaturated bond that is adjacent to the benzene ring, and the unsaturated bond of one of the modified cinnamic acid structural units may undergo a photocyclization reaction with the unsaturated bond of another one of the modified cinnamic acid structural units to form a cyclic structure when the adhesive is subjected to irradiation with a first light source, so that the adhesive is in a form of a closed ring. In certain embodiments, the adhesive in the form of the closed ring may be represented by formula (VIII),

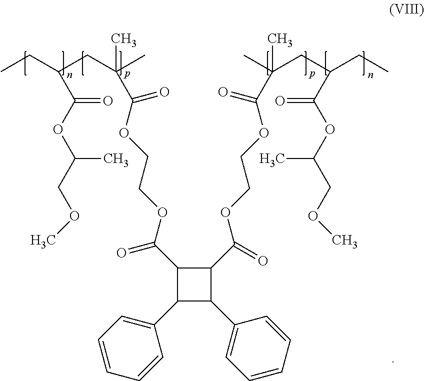

When the adhesive is in the form of the closed ring, the cohesive strength of the adhesive increases, thereby reducing the adhesion thereof.

In certain embodiments, the adhesive in the form of the closed ring may be subjected to irradiation with a second light source, so as to allow the cyclic structure of such adhesive to undergo a photo ring-opening reaction, so that the adhesive may be in a form of an opened ring. In certain embodiments, the adhesive in the form of the opened ring may be represented by formula (IX),

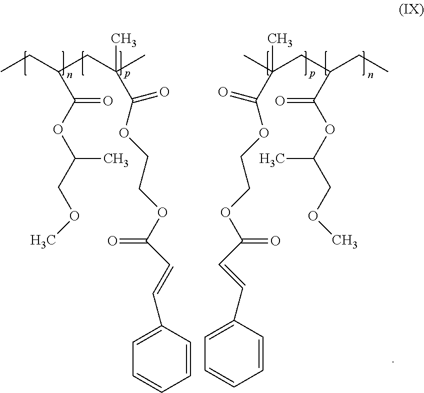

In certain embodiments, an adhesion of the adhesive in the form of the closed ring may be less than an adhesion of the adhesive in the form of the opened ring.

In certain embodiments, the first light source may have a first wavelength ranging from 285 nm to 295 nm. In an exemplary embodiment, the first wavelength of the first light source is 290 nm. It should be noted that, the methyl group, which is initially in the modified cinnamic acid monomer (represented by formula (III)) and is from the 2-hydroxyethyl methacrylate (HEMA), allows the absorption peak of the photocyclization reaction between the unsaturated bond of the one of the modified cinnamic acid structural units (each of which is derived from the modified cinnamic acid monomer and hence has the methyl group) and the unsaturated bond of the another one of the modified cinnamic acid structural units to fall within a range from 285 nm to 295 nm (i.e., range of the first wavelength).

In certain embodiments, the second light source may have a second wavelength ranging from 220 nm to 230 nm. In an exemplary embodiment, the second wavelength of the second light source is 225 nm.

By inclusion of the modified cinnamic acid monomer and the propylene glycol methyl ether acrylate monomer (in some cases, even the acrylic monomer) in the adhesive composition of the present disclosure, the adhesion of the adhesive of the present disclosure formed from the adhesive composition is capable of being altered when the adhesive is subjected to irradiation with different light sources, so that the adhesive can be used repeatedly, and thus two objects bonded by the adhesive are allowed to be separated from or re-adhered to each other.

The present disclosure will be further described by way of the following examples. However, it should be understood that the following examples are intended solely for the purpose of illustration and should not be construed as limiting the present disclosure in practice.

### Preparation Examples

### Preparation of Modified Cinnamic Acid Monomers

10 g of cinnamic acid (Sigma-Aldrich; Model: 8.00235), 8.8 g of 2-hydroxyethyl methacrylate (HEMA) (Sigma-Aldrich; Model: 8.00588), and 100 mL of propylene glycol methyl ether acetate (serving as a second solvent) were mixed and stirred in a water bath having a temperature of 60° C. for 3 hours, thereby obtaining a first mixture. Subsequently, the first mixture was subjected to a catalytic reaction (specifically, an esterification reaction involving a catalyst) conducted in the presence of 0.1 g of dioctyltin dilaurate (Apollo Scientific Ltd.; Model: APOH96F124B7; serving as the catalyst) for 6 hours, thereby obtaining a crude product. The crude product was then subjected to gravity filtration using a filter paper (ADVANTEC; Model: NO. 5C), thereby obtaining a filtrate containing modified cinnamic acid monomers. Thereafter, the filtrate was mixed with cyclohexanone to obtain a second mixture, and then the second mixture was subjected to liquid-liquid extraction using a separatory funnel, followed by collecting an organic layer containing the modified cinnamic acid monomers. Afterwards, the organic layer was subjected to centrifugation using a high-speed centrifuge (ChromTech®; Model: MT-15000), thereby obtaining the modified cinnamic acid monomers.

### Fourier Transform Infrared (FTIR) Spectroscopy Analysis

A suitable amount of the modified cinnamic acid monomers was subjected to FTIR spectroscopy analysis utilizing an FTIR spectrometer (Bruker; Model: VERTEX 80v) in attenuated total reflection (ATR) mode, and FTIR spectrum was collected over a wavenumber ranging from 400 cm⁻¹ to 4000 cm⁻¹ at a resolution of 2 cm⁻¹. The results showed that the modified cinnamic acid monomers had an absorption peak at a wavenumber of 1720 cm⁻¹, indicating the presence of ester groups therein; in addition, there is no absorption peak at a wavenumber of 3453 cm⁻¹, indicating the absence of hydroxyl groups in the modified cinnamic acid monomers. These results demonstrated that the modified cinnamic acid monomers were successfully formed by esterification of the cinnamic acid with the HEMA in the presence of the catalyst.

### Ultraviolet-Visible (UV-Vis) Spectral Analysis

A suitable amount of the modified cinnamic acid monomers was subjected to UV-vis spectral analysis utilizing a UV-vis spectrophotometer (CARY; Model: 300nc), and UV-vis spectrum was collected over a wavelength ranging from 190 nm to 900 nm. The result showed that the modified cinnamic acid monomers had an absorption peak at the wavelength of 290 nm, indicating occurrence of a photocyclization reaction between an unsaturated bond of one of modified cinnamic acid monomers (each having a benzene ring and the unsaturated bond that is adjacent to the benzene ring) and the unsaturated bond of another one of the modified cinnamic acid monomers, thus forming a cyclic structure. Furthermore, the modified cinnamic acid monomers had an absorption peak at the wavelength of 225 nm, indicating that the cyclic structure underwent a photo ring-opening reaction.

### EXAMPLES

### Preparation of Adhesive Composition and Adhesive

### Example 1 (E1)

First, 6 g of the modified cinnamic acid monomers obtained in Preparative Example, 90 g of propylene glycol methyl ester acrylate monomers (OBA) (Shiny Chemical Industrial Co., Ltd.; Model: OBA1), 0.3 g of dimethyl 2,2′-azobis(2-methylpropionate) (FUJIFILM Wako Chemicals USA, Corp.; Model: V-601) (serving as a thermal initiator), 66 mL of n-butyl acetate, and 33 mL of propylene glycol methyl ether acetate (both serving as a first solvent) were mixed, so as to obtain an adhesive composition. Next, the adhesive composition was subjected to a thermal cross-linking reaction at 80° C. for 6 hours, thereby obtaining an adhesive of E1. The thus obtained adhesive of E1 included the first structural unit represented by the aforesaid formula (V), where n was 78, and p was 5.

### Example 2 (E2)

First, 6 g of the modified cinnamic acid monomers obtained in Preparative Example, 10 g of propylene glycol methyl ester acrylate monomers (OBA) (Shiny Chemical Industrial Co., Ltd.; Model: OBA1), 80 g of hydroxyethyl acrylate (2-HEA) (KSK Co., Ltd.; Model: 2-HEA) (serving as an acrylic monomer), 0.3 g of dimethyl 2,2′-azobis(2-methylpropionate) (FUJIFILM Wako Chemicals USA, Corp.; Model: V-601) (serving as a thermal initiator), 66 mL of n-butyl acetate, and 33 mL of propylene glycol methyl ether acetate (both serving as a first solvent) were mixed, so as to obtain an adhesive composition. Next, the adhesive composition was subjected to the thermal cross-linking reaction at 80° C. for 6 hours, thereby obtaining an adhesive of E2. The thus obtained adhesive of E2 included the second structural unit represented by the aforesaid formula (VII-1), where m was 170, n was 17, and p was 10.

### Example 3 (E3)

The procedures for preparing the adhesive composition and the adhesive of E3 was similar to those of E2, except that the hydroxyethyl acrylate used in E2 was replaced with butyl acrylate to serve as an acrylic monomer. Therefore, the thus obtained adhesive of E3 included the second structural unit represented by the aforesaid formula (VII-2), where m was 154, n was 17, and p was 10.

### Property Evaluation

### <Determination of Glass Transition Temperature>

The adhesive of each of E1 to E3 was subjected to a differential scanning calorimetry (DSC) analysis utilizing a differential scanning calorimeter (TA Instruments; Model: Q500), so as to determine the glass transition temperature thereof. The results were shown in Table 1 below.

TABLE 1

| | E1 | E2 | E3 |
|---|---|---|---|
| Glass transition | −40° C. | −15° C. | −52° C. |
| temperature | | | |

### <Irradiation of Adhesive>

The adhesive of each of E1 to E3 was coated on a thin plate to form an adhesion layer thereon. The adhesion layer made of the adhesive had a thickness of 65 μm. Thereafter, the adhesive (i.e., the adhesion layer on the thin plate) was consecutively subjected to irradiation for five rounds, and each of the five rounds was conducted as follows. Specifically, the adhesive that formed the adhesion layer on the thin plate was subjected to irradiation with ultraviolet light (serving as a first light source) having a wavelength of 290 nm, so that an unsaturated bond of one of modified cinnamic acid structural units (which were included in the adhesive; each of which had a benzene ring and the unsaturated bond that was adjacent to the benzene ring) undergoes a photocyclization reaction with the unsaturated bond of another one of the modified cinnamic acid structural units to form a cyclic structure, so as to obtain the adhesive that was in a form of a closed ring and that was represented by formula (VIII). Subsequently, the adhesive in the form of the closed ring on the thin plate was subjected to irradiation with ultraviolet light (serving as a second light source) having a wavelength of 225 nm, so as to allow the cyclic structure of the adhesive in the form of the closed ring to undergo a photo ring-opening reaction, so as to obtain the adhesive that was in a form of an opened ring and that was represented by formula (IX).

### <Determination of Peel Strength>

In each of the five rounds (namely, 1^{st} round, 2^{nd} round, 3^{rd} round, 4^{th} round, and 5^{th} round, respectively) of irradiation as described above in the Section “Irradiation of adhesive”, the adhesive of each of E1 to E3 (in the form of the closed ring or opened ring) on the thin plate was subjected to determination of peel strength in accordance with the American Society for Testing and Materials (ASTM) D3330 (Standard Test Method for Peel Adhesion of Pressure-Sensitive Tape) using a tensile strength tester (ZwickRoell; Model: Z0.5TH). The results were shown in Table 2 below.

TABLE 2

| | | Peel strength (gram-force (gf)/inch (in)) | | | | |
|---|---|---|---|---|---|---|
| | | 1^{st} | 2^{nd} | 3^{rd} | 4th | 5^{th} |
| | | round | round | round | round | round |
| E1 | Adhesive in the | 12 ± | 11 ± | 11 ± | 13 ± | 11 ± |
| | form of closed ring | 1 | 1 | 1 | 1 | 1 |
| | Adhesive in the | 285 ± | 287 ± | 288 ± | 287 ± | 286 ± |
| | form of opened | 1 | 1 | 1 | 1 | 1 |
| | ring | | | | | |
| E2 | Adhesive in the | 2 ± | 3 ± | 3 ± | 2 ± | 2 ± |
| | form of closed ring | 1 | 1 | 1 | 1 | 1 |
| | Adhesive in the | 66 ± | 63 ± | 66 ± | 67 ± | 68 ± |
| | form of opened | 1 | 1 | 1 | 1 | 1 |
| | ring | | | | | |
| E3 | Adhesive in the | 22 ± | 21 ± | 22 ± | 23 ± | 22 ± |
| | form of closed ring | 1 | 1 | 1 | 1 | 1 |
| | Adhesive in the | 425 ± | 419 ± | 417 ± | 420 ± | 423 ± |
| | form of opened | 1 | 1 | 1 | 1 | 1 |
| | ring | | | | | |

Referring to Table 2, in each of E1 to E3, the peel strengths determined in the five rounds for the adhesive in the form of the opened ring were higher than those of the adhesive in the form of the closed ring, showing that the adhesive of the present disclosure had different adhesions after being subjected to the irradiation with light sources having different wavelengths, e.g., the ultraviolet light having the wavelength of 290 nm and the ultraviolet light having the wavelength of 225 nm, indicating that two objects bonded using the adhesive of the present disclosure are capable of being separated from or re-adhered to each other.

### <Determination of Adhesion>

In each of the five rounds of irradiation as described above in the Section “Irradiation of adhesive”, the adhesive (in the form of the closed ring or opened ring) of each of E1 to E3 on the thin plate was subjected to determination of adhesion in accordance with the National Standards of the Republic of China (CNS) 11888 (Methods of Test for Pressure Sensitive Adhesive Tapes and Sheets) using a rolling ball viscosity meter (GOTECH; Model: GT-7218-A) and a metal ball having a weight of 0.2 g or 1.05 g. It should be noted that the adhesions were measured as a distance in units of mm, and that the larger the value of the distance is, the lesser the adhesion of the adhesive is. The results were shown in Tables 3 (the adhesions determined using the metal ball having the weight of 0.2 g) and 4 (the adhesions determined using the metal ball having the weight of 1.05 g) below.

TABLE 3

| | | Adhesion (mm) | | | | |
|---|---|---|---|---|---|---|
| | | 1^{st} | 2^{nd} | 3^{rd} | 4^{th} | 5^{th} |
| | | round | round | round | round | round |
| E1 | Adhesive in the | 43.2 ± | 43.3 ± | 42.8 ± | 43.1 ± | 43.1 ± |
| | form of closed ring | 0.1 | 0.1 | 0.1 | 0.1 | 0.1 |
| | Adhesive in the | 18.2 ± | 17.3 ± | 18.5 ± | 18.1 ± | 17.7 ± |
| | form of opened | 0.1 | 0.1 | 0.1 | 0.1 | 0.1 |
| | ring | | | | | |
| E2 | Adhesive in the | 60.1 ± | 61.2 ± | 60.7 ± | 60.3 ± | 60.8 ± |
| | form of closed ring | 0.1 | 0.1 | 0.1 | 0.1 | 0.1 |
| | Adhesive in the | 35.2 ± | 34.8 ± | 35.1 ± | 35.1 ± | 35.3 ± |
| | form of opened | 0.1 | 0.1 | 0.1 | 0.1 | 0.1 |
| | ring | | | | | |
| E3 | Adhesive in the | 25.3 ± | 26.2 ± | 25.5 ± | 25.7 ± | 25.3 ± |
| | form of closed ring | 0.1 | 0.1 | 0.1 | 0.1 | 0.1 |
| | Adhesive in the | 8.1 ± | 8.3 ± | 8.1 ± | 8.2 ± | 8.2 ± |
| | form of opened | 0.1 | 0.1 | 0.1 | 0.1 | 0.1 |
| | ring | | | | | |

TABLE 4

| | | Adhesion (mm) | | | | |
|---|---|---|---|---|---|---|
| | | 1^{st} | 2^{nd} | 3^{rd} | 4^{th} | 5^{th} |
| | | round | round | round | round | round |
| E1 | Adhesive in the | 120.3 ± | 120.1 ± | 120.2 ± | 121.3 ± | 121.1 ± |
| | form of closed ring | 0.1 | 0.1 | 0.1 | 0.1 | 0.1 |
| | Adhesive in the | 72.8 ± | 73.5 ± | 73.3 ± | 72.8 ± | 74.0 ± |
| | form of opened | 0.1 | 0.1 | 0.1 | 0.1 | 0.1 |
| | ring | | | | | |
| E2 | Adhesive in the | 190.3 ± | 190.1 ± | 190.2 ± | 191.3 ± | 191.1 ± |
| | form of closed ring | 0.1 | 0.1 | 0.1 | 0.1 | 0.1 |
| | Adhesive in the | 95.2 ± | 95.8 ± | 95.3 ± | 95.6 ± | 95.8 ± |
| | form of opened | 0.1 | 0.1 | 0.1 | 0.1 | 0.1 |
| | ring | | | | | |
| E3 | Adhesive in the | 85.3 ± | 86.2 ± | 85.5 ± | 85.8 ± | 85.7 ± |
| | form of closed ring | 0.1 | 0.1 | 0.1 | 0.1 | 0.1 |
| | Adhesive in the | 21.5 ± | 22.3 ± | 22.5 ± | 21.8 ± | 22.1 ± |
| | form of opened | 0.1 | 0.1 | 0.1 | 0.1 | 0.1 |
| | ring | | | | | |

Referring to Tables 3 and 4, in each of E1 to E3, the adhesions determined in the five rounds for the adhesive in the form of the opened ring were higher (due to having lower values) than those of the adhesive in the form of the closed ring, demonstrating that the adhesive of the present disclosure had different adhesions after being subjected to the irradiation with light sources having different wavelengths, e.g., the ultraviolet light having the wavelength of 290 nm and the ultraviolet light having the wavelength of 225 nm, indicating that two objects bonded using the adhesive of the present disclosure are capable of being separated from or re-adhered to each other.

To sum up, by virtue of inclusion of the modified cinnamic acid monomer and the propylene glycol methyl ether acrylate monomer (in some cases, the acrylic monomer is additionally included) in the adhesive composition according to the disclosure, the adhesion of the adhesive formed from the adhesive composition can be altered when the adhesive is subjected to irradiation with different light sources, so that two objects bonded using the adhesive can be separated from or re-adhered to each other, thereby allowing the adhesive to be used repeatedly. Therefore, the purpose of the invention can be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An adhesive composition, comprising:
a modified cinnamic acid monomer formed by subjecting a component which includes cinnamic acid, 2-hydroxyethyl methacrylate, and a catalyst to an esterification reaction,
a propylene glycol methyl ether acrylate monomer,
an initiator, and
a first solvent including n-butyl acetate.

2. The adhesive composition as claimed in claim 1, wherein the first solvent further includes propylene glycol methyl ether acetate, a volume ratio of the n-butyl acetate to the propylene glycol methyl ether acetate being greater than 1 in decimal form.

3. The adhesive composition as claimed in claim 1, wherein based on a total amount of the modified cinnamic acid monomer as 100 parts by weight, the propylene glycol methyl ether acrylate monomer is present in an amount ranging from 100 parts by weight to 2000 parts by weight, and the initiator is present in an amount ranging from 4 parts by weight to 6 parts by weight.

4. The adhesive composition as claimed in claim 1, further comprising an acrylic monomer selected from the group consisting of hydroxyethyl acrylate, butyl acrylate, and 2-ethylhexyl acrylate.

5. The adhesive composition as claimed in claim 4, wherein based on a total amount of the modified cinnamic acid monomer, the propylene glycol methyl ether acrylate monomer, the acrylic monomer, and the initiator as 100 wt %, the modified cinnamic acid monomer is present in an amount ranging from 4.9 wt % to 9.9 wt %, a total amount of the propylene glycol methyl ether acrylate monomer and the acrylic monomer ranges from 90 wt % to 95 wt %, and the initiator is present in an amount ranging from 0.1 wt % to 0.5 wt %.

6. The adhesive composition as claimed in claim 1, wherein the initiator is selected from the group consisting of a thermal initiator, a photoinitiator, and a combination thereof.

7. An adhesive, which is formed by subjecting an adhesive composition as claimed in claim 1 to a cross-linking reaction, wherein the adhesive includes modified cinnamic acid structural units each of which is represented by formula (I), and propylene glycol methyl ether acrylate structural units each of which is represented by formula (II),

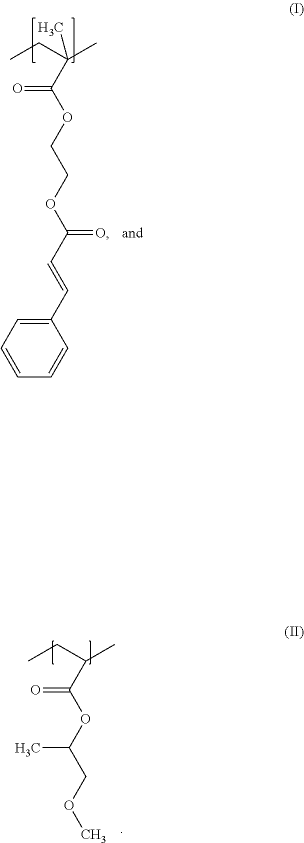

8. The adhesive as claimed in claim 7, wherein
each of the modified cinnamic acid structural units has a benzene ring and an unsaturated bond that is adjacent to the benzene ring, and
the unsaturated bond of one of the modified cinnamic acid structural units undergoes a photocyclization reaction with the unsaturated bond of another one of the modified cinnamic acid structural units to form a cyclic structure when the adhesive is subjected to irradiation with a first light source, so that the adhesive is in a form of a closed ring.

9. The adhesive as claimed in claim 8, wherein the adhesive in the form of the closed ring is subjected to irradiation with a second light source, so as to allow the cyclic structure of the adhesive in the form of the closed ring to undergo a photo ring-opening reaction, so that the adhesive is in a form of an opened ring.

10. The adhesive as claimed in claim 9, wherein an adhesion of the adhesive in the form of the closed ring is less than an adhesion of the adhesive in the form of the opened ring.

11. The adhesive as claimed in claim 8, wherein the first light source has a first wavelength ranging from 285 nm to 295 nm.

12. The adhesive as claimed in claim 9, wherein the second light source has a second wavelength ranging from 220 nm to 230 nm.

13. The adhesive as claimed in claim 7, which has a glass transition temperature ranging from −40° C. to −60° C.
